(19) United States
(12) Patent Application Publication
(10) Pub. No.: US 2007/0012567 A1
(43) Pub. Date: Jan. 18, 2007

(54) Gas sensor designed to have enhanced thermal durability and mountability

(75) Inventor: Kazuya Nakagawa, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/485,969

(22) Filed: Jul. 14, 2006

(30) Foreign Application Priority Data
Jul. 14, 2005 (JP) 2005-205729

(51) Int. Cl. G01N 27/26

(52) U.S. Cl. 204/431

(57) ABSTRACT

A gas sensor is provided which has a water-repellent filter and a rubber tube through which air is admitted to inside the gas sensor. The water-repellent filter extends from an end of an air cover in a lengthwise direction of the gas sensor and is kept in a lower-temperature atmosphere to have enhanced thermal durability. The water-repellent filter is retained by a first and a second cover around an outer periphery of the rubber tube in contact therewith. The first and second cover are located away from each other in the lengthwise direction of the gas sensor so as to provide the flexibility to the water-repellent filter and the rubber tube, thereby permitting them to be bent elastically to decrease an overall height of the gas sensor, which facilitates ease of installation of the gas sensor in a narrow space.

### CROSS REFERENCE TO RELATED DOCUMENT

The present application claims the benefit of Japanese Patent Application No. 2005-205729 filed on Jul. 14, 2005, the disclosure of which is incorporated herein by reference.

### BACKGROUND OF THE INVENTION

1. Technical Field of the Invention

The present invention relates generally to a gas sensor which is partially exposed to, for example, high-temperature exhaust gas for measuring the concentration of a given gas component.

2. Background Art

There are known gas sensors installed in an exhaust pipe of an automotive engine for use in air-fuel ratio control of the engine. The gas sensors have a top portion (i.e., a sensing portion) exposed to intense heat produced by exhaust gas flowing within the exhaust pipe and a base portion exposed to air. The temperature of the gas sensors, therefore, drops gradually from the top portion toward the end of the base portion.

The above type of gas sensor usually includes an air cover having formed therein air inlets through which air is admitted to inside the gas sensor. The air inlets are covered with a water-repellent filter to avoid intrusion of water thereinto. The water-repellent filter is usually made of porous resin and may be deformed or changed in elasticity resulting in loosening of joints of the water-repellent filter to the air cover when subjected to heat. Additionally, extended exposure to heat may cause pores of the water-repellent filter to be deformed thermally or decreased in size, thus resulting in decreased air permeability of the water-repellent filter. This results in a decrease in amount of oxygen within the gas sensor and an error in measuring the concentration of the gas. In order to alleviate this problem, the water-repellent filter needs to be located as far away from the top of the gas sensor as possible and kept in a lower-temperature atmosphere.

For example Japanese Patent First Publication No. 2004-198361 (US2004/0129566 A1) discloses the water-repellent filter extending toward the base end of the gas sensor. This structure, however, encounters the problem in that the extended length of the water-repellent filter results in an increased overall length of the gas sensor which leads to an increased difficulty in installation in automotive vehicles.

### SUMMARY OF THE INVENTION

It is therefore a principal object of the invention to avoid the disadvantages of the prior art.

It is another object of the invention to provide an improved structure of a gas sensor which is designed to keep a water-repellent filter in a lower-temperature atmosphere and has improved mountability of the gas sensor in, for example, a vehicle.

According to one aspect of the invention, there is provided an improved structure of a gas sensor working to measure a given component content in a gas. The gas sensor comprises: (a) a hollow cylindrical housing having a top end and a base end opposed to the top end; (b) a sensor element disposed in the housing, the sensor element having a length made up of a base portion and a top portion, the top portion working as a sensing portion to be exposed to a gas to be sensed; (c) a cylindrical air cover joined to the base end of the housing to surround the base portion of the sensor element; (d) a cylindrical flexible member having an air inlet formed in an outer periphery thereof, the flexible member having a top end and a base end opposed to the top end; (e) a filter fitted on the outer periphery of the flexible member, having a top end and a base end opposed to the top end, the filter working to permits air to pass therethrough; (f) a sealing member fitted in the base end of the flexible member; (g) a first cover retaining the top ends of the filter and the flexible member between itself and the base end of the air cover; and (h) a second cover retaining the base ends of the filter and the flexible member between itself and the sealing member. The second cover is located at a given interval away from the first cover in a lengthwise direction of the gas sensor. The interval faces the air inlet of the flexible member.

The filter is located far away from the base end of the air cover and thus kept in a lower-temperature atmosphere remote from the top of the gas sensor subjected to intense heat. The first and second covers are located away from each other to provide the mechanical flexibility to the filter and the flexible member, thus permitting the filter and the flexible member to be deformed or bent to decrease the height of the gas sensor. This facilitates ease of installation of the gas sensor in a narrow space.

In the preferred mode of the invention, the first cover is crimped at a peripheral wall thereof to nip the filter and the flexible member between itself and the air cover. The second cover is crimped at a peripheral wall thereof to nip the filter and the flexible member between itself and the flexible member.

A rubber band may be wound around at least one of the first and second covers to cramp the filter and the flexible member together.

The flexible member is made of fluorocarbon rubber.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a structure of a gas sensor according to the invention;

FIG. 2 is a partially enlarged view of a portion of the gas sensor, as enclosed by a circle A in FIG. 1; and

FIG. 3 is a longitudinal sectional view which shows the gas sensor of FIG. 1 when being bent at a rubber tube and a water-repellent filter.

### DESCRIPTION OF THE PREFERRED EMBODIMENTS

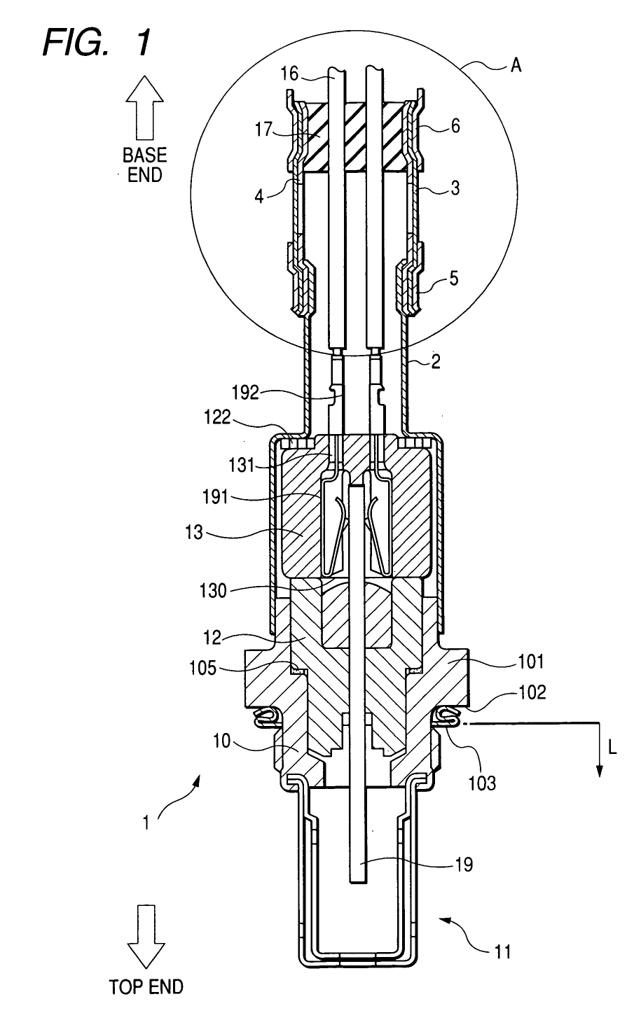

Referring to the drawings, wherein like reference numbers refer to like parts in several views, particularly to FIG. 1, there is shown a gas sensor 1 according to the invention which may be installed in an exhaust system of an automotive internal combustion engine to measure the concentration of a given component such as O₂, NOx, CO, or HC contained in exhaust emissions for burning control of the engine.

The gas sensor 1 includes a hollow cylindrical housing 10, a sensor element 19 disposed within the housing 10, a protective cover assembly 11 joined to a top end (i.e., a lower end, as viewed in the drawing) of the housing 10 to surround a top portion (i.e., a sensing portion) of the sensor element 19, and a hollow cylindrical air cover 2 joined to a base end (i.e., an upper end, as viewed in the drawing) of the housing 10 to surround a base portion of the sensor element 10.

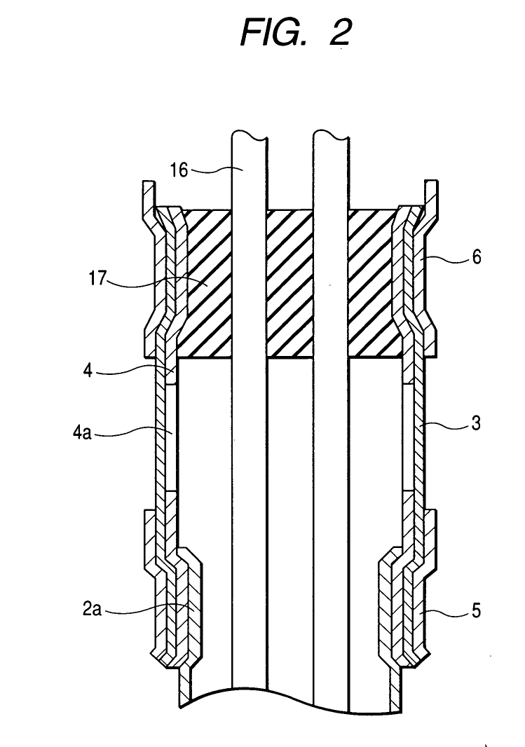

The gas sensor 1 also includes a water-repellent filter 3, a cylindrical rubber tube 4, a rubber bush 17 serving as an elastic seal, a first cover 5, and a second cover 6. The rubber tube 4 is affixed at an end thereof to an end of the air cover 2 and extends in a lengthwise direction of the gas sensor 1. The rubber tube 4 is covered with the water-repellent filter 3 and has formed therein, as clearly illustrated in FIG. 2, air inlets 4a through which air enters inside the rubber tube 4 through the water-repellent filter 3. The rubber bush 17 is fitted within a base end of the rubber tube 4. The first cover 5 is crimped to nip top portions of the water-repellent filter 3 and the rubber tube 4 between itself and a base end 2a of the air cover 2. The second cover 6 is, like the first cover 5, crimped to nip base end portions of the water-repellent filter 3 and the rubber tube 4 between itself and the rubber bush 17. The first cover 5 and the second cover 6 are aligned in the lengthwise direction of the gas sensor 1 at a given interval away from each other. The air inlets 4a of the rubber tube 4 are located between the first cover 5 and the second cover 6.

The first cover 5 and the second cover 6 are each made of a stainless steel (SUS304) and are of a hollow cylindrical shape. The rubber tube 4 is made of fluorocarbon rubber and of a hollow cylindrical shape. The water-repellent filter 3 is made of a porous material having the permeability to air such as polytetrafluoroethylene (PTFE).

The above structure of the gas sensor 1 has the water-repellent filter 3 located farther away from the top of the gas sensor 1 exposed to intense heat than the base end 2a of the air cover 2, thus keeping the water-repellent filter 3 in a relatively low temperature atmosphere and permits the rubber tube 4 to be deformed, bent, or compressed vertically to decrease the overall length, that is, a minimum distance between the ends of the gas sensor 1, thus facilitating ease of installation of the gas sensor 1 in an automotive vehicle.

The gas sensor 1 may be used as an air-fuel ratio sensor working to determine an air-fuel ratio of a mixture supplied to an automotive internal combustion engine. In use, the gas sensor 1 is installed in an exhaust pipe of the engine to expose the sensor element 19 to exhaust gas flowing within the exhaust pipe. The installation of the gas sensor 1 is achieved by screwing a top portion of the housing 10 into the outer wall of the exhaust pipe and placing a top end surface 102 of a flange 101 of the housing 10 in abutment with the outer wall of the exhaust pipe through an annular spring 103. The spring 103 serves to form a hermetic seal between the inside the exhaust pipe and the flange 101.

A portion of the gas sensor 1 closer to the top end (i.e., a lower end, as viewed in FIG. 1) than a line L is subjected to intense heat as produced by the exhaust gas of the engine flowing within the exhaust pipe. The remaining portion of the gas sensor 1 closer to the base end (i.e., an upper end, as viewed in FIG. 1) than the line L is exposed to air. Consequently, the temperature of the gas sensor 1 drops from the line L to the base end of the gas sensor 1.

The protective cover assembly 11 is, as described above in FIG. 1, affixed to the top end of the housing 10. The protective cover assembly 11 has a double-walled structure made up of an outer cover and an inner cover which have gas inlets formed in side walls thereof. The inner cover has defined therein a gas chamber within which the sensing portion of the sensor element 19 is exposed to the exhaust gas of the engine to be measured.

Within the housing 10, a porcelain insulator 12 is disposed to retain the sensor element 19. Clearances between the porcelain insulator 12 and the housing 10 and between the porcelain insulator 12 and the sensor element 19 are hermetically sealed to block passage of the gas.

A porcelain insulator 13 is disposed on the porcelain insulator 12 in alignment with each other. A disc spring 122 is nipped elastically between an outer shoulder wall of the porcelain insulator 13 and an inner shoulder wall of the air cover 2 to produce spring pressure. The spring pressure works to urge the porcelain insulator 12 in a direction substantially parallel to the center line of the gas sensor 1 into constant abutment with an inner tapered shoulder 105 of the housing 10 through the porcelain insulator 13.

The porcelain insulator 13 has formed therein a cylindrical chamber 130 within which the base portion of the sensor element 19 is disposed. The cylindrical chamber 130 communicates with the inside of the air cover 2 through air inlets 131.

Terminals 191 are disposed inside the porcelain insulator 13. The terminals 191 extend through the air inlets 131 and are joined to leads 16 through terminal connectors 192 electrically. The leads 16 are coupled with an external sensor controller equipped with a power supply to transmit a sensor output thereto and supply electric power to the sensor element 19 therefrom.

The air cover 2 is welded directly to an outer wall of the base end of the housing 10. The air cover 2 is of a cylindrical shape and made of stainless steel (SUS304).

As apparent from the above discussion, the rubber bush 17 has no air inlet. The air inlets 4a are formed only in the rubber tube 4. It is, therefore, easy to form the air inlets 4a with a simple structure.

The rubber bush 17 may be decreased in a cross sectional area slightly greater than a total of cross sectional areas of the leads 16. For instance, when the diameter of the leads 16 is 2 mm, and the number of the leads 16 is four (4), the cross sectional area of the rubber bush 17 may be greater than 16 mm².

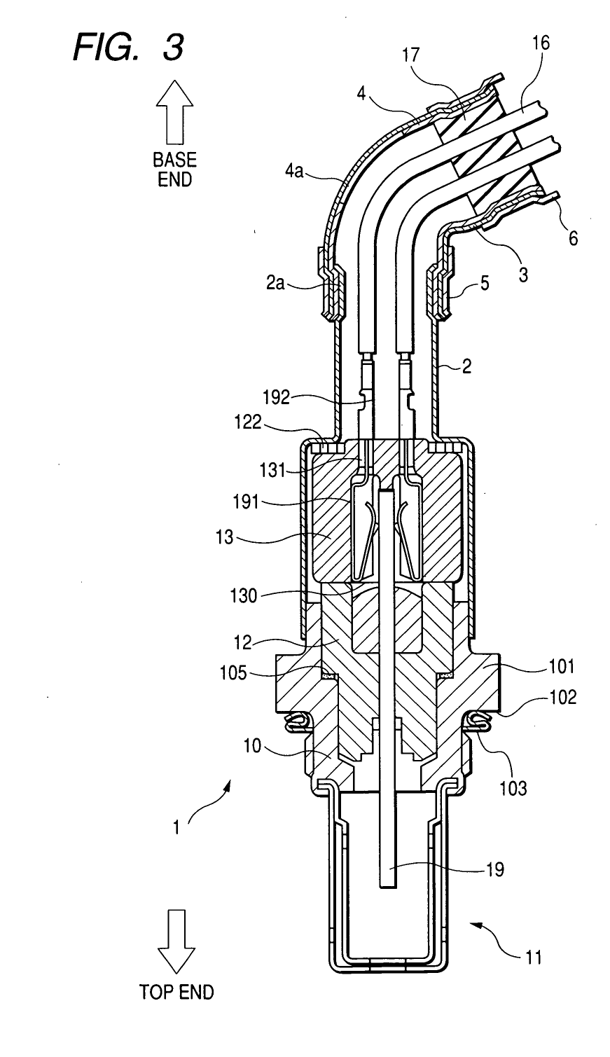

FIG. 3 is a longitudinal sectional view which shows the gas sensor 1 which is bent elastically at the rubber tube 4, thereby resulting in a decreased overall height which enhances the mountability thereof in the vehicle.

The rubber tube 5 may alternatively be made of a heat resistant material such as silicon rubber. The installation of the water-repellent filter 3 and the rubber tube 4 may alternatively be achieved by winding a rubber band(s) from outside at least one of the first and second covers 5 and 6 to hold or cramp the water-repellent filter 3 and the rubber tube 4 tightly against the rubber bush 17 and the air cover 2.

The gas sensor 1 may be designed, as described above, to measure the concentration of NOx, CO, or HC contained in exhaust emissions for burning control of the engine. The sensor element 19 may be of a known cup-shaped or laminated shaped structure.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor having a length comprising:
a hollow cylindrical housing having a top end and a base end opposed to the top end;
a sensor element disposed in said housing, said sensor element having a length made up of a base portion and a top portion, the top portion working as a sensing portion to be exposed to a gas to be sensed;
a cylindrical air cover joined to the base end of said housing to surround the base portion of said sensor element;
a cylindrical flexible member having an air inlet formed in an outer periphery thereof, said flexible member having a top end and a base end opposed to the top end;
a filter fitted on the outer periphery of said flexible member, having a top end and a base end opposed to the top end, said filter working to permits air to pass therethrough;
a sealing member fitted in the base end of said flexible member;
a first cover retaining the top ends of said filter and said flexible member between itself and the base end of the air cover; and
a second cover retaining the base ends of said filter and said flexible member between itself and said sealing member, the second cover being located at a given interval away from said first cover in a lengthwise direction of the gas sensor, the interval facing the air inlet of said flexible member.

2. A gas sensor as set forth in claim 1, wherein said first cover is crimped at a peripheral wall thereof to nip said filter and said flexible member between itself and said air cover, and wherein said second cover is crimped at a peripheral wall thereof to nip said filter and said flexible member between itself and said flexible member.

3. A gas sensor as set forth in claim 1, further comprising a rubber band wound around at least one of said first and second covers to cramp said filter and said flexible member together.

4. A gas sensor as set forth in claim 1, wherein said flexible member is made of fluorocarbon rubber.
